(19) United States
(12) Patent Application Publication
(10) Pub. No.: US 2025/0032977 A1
(43) Pub. Date: Jan. 30, 2025

(54) ATMOSPHERIC WATER HARVESTING USING FOG HARVESTING FABRIC

(71) Applicant: International Business Machines Corporation, Armonk, NY (US)

(72) Inventors: Tyler Waite, Lake Washington, WA (US); Jason Andrew Telner, Lackawanna,, NY (US); Peter Guzewich, Vestal, NY (US); Jon Gerard Temple, Southbury, CT (US); Donna Thelander, Kailua Kona, HI (US); Mark Willard Malatesta, Ortonville, MI (US)

(21) Appl. No.: 18/358,173

(22) Filed: Jul. 25, 2023

(51) Int. Cl. B01D 53/30; B01D 53/26; B64U 10/60

(52) U.S. Cl. CPC B01D 53/30; B01D 53/265; B64U 10/60; B01D 2257/80; B64U 2101/10; B64U 2101/30

(57) ABSTRACT

Embodiments include an atmospheric water harvesting system and method for using the same. Aspects include receiving atmospheric data corresponding to a harvest area of the atmospheric water harvesting system and determining, based at least in part on the atmospheric data, that atmospheric conditions in the harvest area are conducive for atmospheric water harvesting. Aspects also include deploying an unmanned aerial vehicle (UAV) including a fog harvesting fabric into the harvest area and receiving, by a water reservoir tethered to the UAV by a tubing configured to transfer water from the fog harvesting fabric to the water reservoir, harvested water.

### BACKGROUND

The present disclosure generally relates to atmospheric water harvesting, and more specifically, to methods and systems for performing atmospheric water harvesting using fog harvesting fabric.

Reliable access to water for both consumption and agricultural applications is a basic need for individuals around the world. One common source of obtaining fresh water has been drilling wells, however, the cost of drilling a well is expensive and there is no guarantee that a drilled well will actually find water. Another source of obtaining fresh water is atmospheric water harvesting. For example, using a fog harvesting fabric to capture water droplets from foggy air and convert them into liquid water. Fog harvesting fabrics are mesh or net-like materials made of specialized fibers with small openings. When tiny water droplets suspended in the air come into contact with the fog harvesting fabric. The droplets collide with the fibers of the fabric and get trapped on the surface. The fabric's structure and surface properties, such as hydrophilicity, help in capturing and retaining the water droplets. As the fog droplets accumulate on the fabric, they begin to coalesce and merge into larger water droplets. Eventually, the larger droplets run down the fabric under the force of gravity.

Recently, advances in fog harvesting fabric have been made that have resulted in the ability to harvest up to thirteen liters of water per meter of fabric from the atmosphere. In existing atmospheric water harvesting, a fog harvesting fabric is typically attached to poles in a fixed location.

### SUMMARY

Embodiments of the present disclosure are directed to computer-implemented methods for performing atmospheric water harvesting. According to an aspect, a computer-implemented method includes receiving atmospheric data corresponding to a harvest area of the atmospheric water harvesting system and determining, based at least in part on the atmospheric data, that atmospheric conditions in the harvest area are conducive for atmospheric water harvesting. Aspects also include deploying an unmanned aerial vehicle (UAV) including a fog harvesting fabric into the harvest area and receiving, by a water reservoir tethered to the UAV by a tubing configured to transfer water from the fog harvesting fabric to the water reservoir, harvested water.

Embodiments of the present disclosure are directed to a system for performing atmospheric water harvesting. According to an aspect, the system includes a power source, an unmanned aerial vehicle (UAV) including a fog harvesting fabric, and a base station, configured to receive power from the power source, the base station having processor and a water reservoir, wherein the water reservoir is tethered to the UAV by a tubing configured to transfer water from the fog harvesting fabric to the water reservoir. The processor of the base station is configured to selectively deploy the UAV based on atmospheric conditions in a geographic area including the atmospheric water harvesting system.

Embodiments of the present disclosure are directed to a computing system having a memory having computer readable instructions and one or more processors for executing the computer readable instructions. The computer readable instructions controlling the one or more processors to perform operations including receiving atmospheric data corresponding to a harvest area of the atmospheric water harvesting system and determining, based at least in part on the atmospheric data, that atmospheric conditions in the harvest area are conducive for atmospheric water harvesting. The operations also include deploying an unmanned aerial vehicle (UAV) including a fog harvesting fabric into the harvest area and receiving, by a water reservoir tethered to the UAV by a tubing configured to transfer water from the fog harvesting fabric to the water reservoir, harvested water.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram of an example computer system for use in conjunction with one or more embodiments of the present disclosure;

FIG. 2 depicts a schematic diagram of a system for atmospheric water harvesting in accordance with one or more embodiments of the present disclosure;

FIG. 3 depicts a block diagram of a system for atmospheric water harvesting in accordance with one or more embodiments of the present disclosure;

FIG. 4 depict images captured by an unmanned aerial vehicle (UAV) that are used during atmospheric water harvesting by the UAV in accordance with one or more embodiments of the present disclosure;

FIG. 5A depicts a schematic diagram of a system for atmospheric water harvesting including a plurality of UAVs in accordance with one or more embodiments of the present disclosure;

FIG. 5B depicts a diagram of a system for atmospheric water harvesting using a UAV tethered to a water reservoir in accordance with one or more embodiments of the present disclosure; and

FIG. 6 depicts a flowchart of a method for performing atmospheric water harvesting in accordance with one or more embodiments of the present disclosure.

### DETAILED DESCRIPTION

As discussed above, currently available fog harvesting fabrics have the ability to harvest up to thirteen liters of water per meter of fabric from the atmosphere. However, the ability of the current atmospheric water harvesting system to harvest larger amounts of water is limited due to the fog harvesting fabric being disposed in fixed locations.

Exemplary embodiments include methods, systems, and computer program products for improved atmospheric water harvesting using fog harvesting fabric are provided. In exemplary embodiments, the atmospheric water harvesting system includes an unmanned aerial vehicle (UAV) that includes a fog harvesting fabric. The UAV is tethered to a water reservoir by a tubing that is configured to transfer water from the fog harvesting fabric to the water reservoir. In one embodiment, the tubing includes a conductive path for providing power and/or electrical communications to the UAV. In exemplary embodiments, the atmospheric water harvesting system is configured to selectively deploy the UAV to harvest water from the atmosphere based on atmospheric data that is collected, or received by, a base station associated with the water reservoir. In one embodiment, the atmospheric water harvesting system includes a plurality of base stations and UAVs that are interconnected in a geographic region that is prone to fog accumulation.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as performing atmospheric water harvesting 150. In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 130, Cloud orchestration module 131, host physical machine set 142, virtual machine set 143, and container set 144.

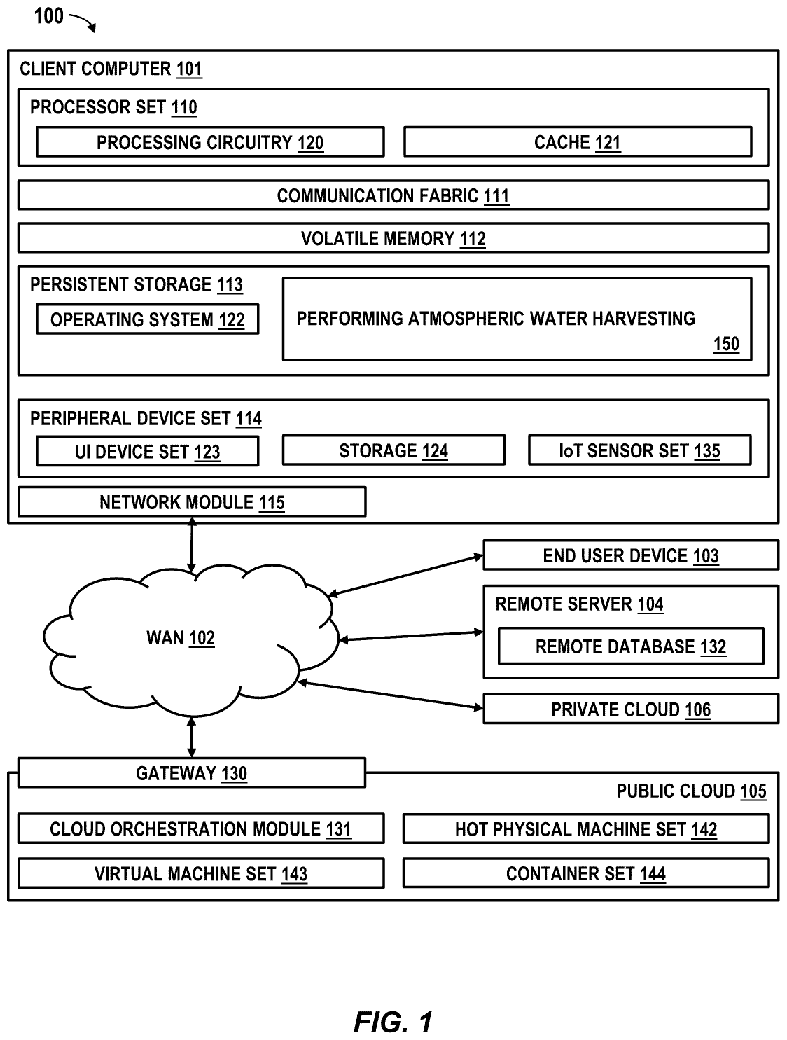

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 132, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

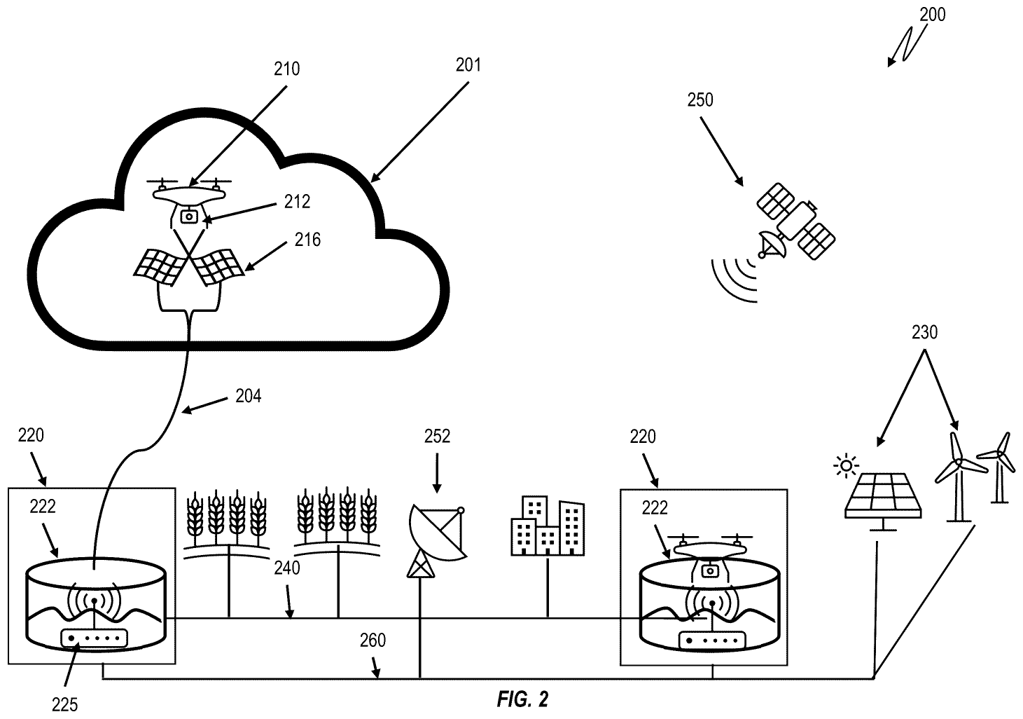

Referring now to FIG. 2, a block diagram of a system 200 for atmospheric water harvesting in accordance with one or more embodiments of the present disclosure is shown. As illustrated, the system 200 includes an unmanned aerial vehicle (UAV) 210 that is configured to harvest atmospheric water from a harvest area 201 using a fog harvesting fabric 216 that is affixed to the UAV 210. The fog harvesting fabric 216 includes one or more water collection channels that are connected to a tubing 204. The tubing 204 tethers the UAV 210 to a water reservoir 222 and transfers water collected by the fog harvesting fabric 216 to the water reservoir 222. In exemplary embodiments, the tubing 204 includes a conductive material to facilitate power transmission from a base station 220, which includes the water reservoir 222, to the UAV 210. In exemplary embodiments, the tubing 204 is configured to limit the area in which the UAV 210 can operate, i.e., the harvest area, and to prevent the UAV from being blown out of the harvest area 201.

In exemplary embodiments, the UAV 210 includes a camera 212 and a processor (not shown) that is configured to obtain and analyze images captured by the camera 212. The processor of the UAV 210 is configured to control a flight path of the UAV as the UAV traverses the harvest area. In one embodiment, the UAV is configured to fly a default flight path through the harvest area 201 to perform water harvesting and to collect images along the default flight path. Once the default flight path has been traversed, the UAV 210 analyzes the images captured and identifies portions of the harvest area 201 to navigate to. In another embodiment, the UAV is configured to fly to a default location in the harvest area 201, collect one or more images of the harvest area, analyze the collected images, and to traverse at least a portion of the harvest area to perform atmospheric water harvesting.

In exemplary embodiments, the system 200 for atmospheric water harvesting includes one or more power sources 230, such as solar or wind power generation devices. The power sources 230 are connected to one or more base stations 220 via a power distribution system 260. In exemplary embodiments, the power collected by the power sources 230 is used to provide power to operate the UAVs 210 and the base stations 220. In exemplary embodiments, the system 200 for atmospheric water harvesting also includes a water distribution system 240 that is configured to distribute water from the water reservoirs 222 to buildings, agricultural irrigation systems, and the like. Although illustrated separately, the water distribution system 240 and the power distribution system 260 may be combined using tubing that includes conductive elements.

In exemplary embodiments, the base stations 220 include communications equipment 225 that is configured to receive data from one or more communications devices 252, 250 regarding atmospheric conditions in the harvest area 201. In addition, the base stations 220 may include sensors (not shown) that are configured to monitor atmospheric conditions in the harvest area 201. In exemplary embodiments, the base stations 220 are configured to selectively deploy the UAV 210 tethered to the water reservoir 222 to perform atmospheric water harvesting based on one or more of the atmospheric conditions in the harvest area 201 and a water level in the water reservoir 222.

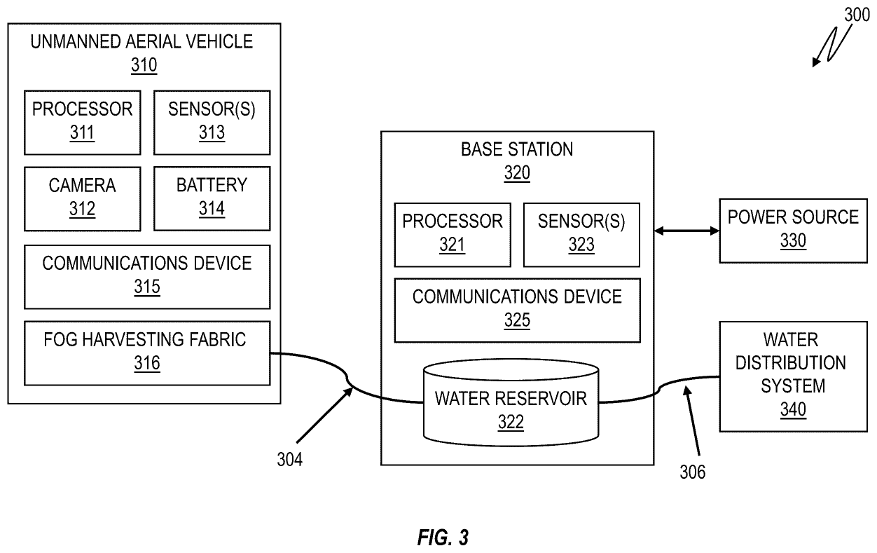

Referring now to FIG. 3, a block diagram of a system 300 for atmospheric water harvesting in accordance with one or more embodiments of the present disclosure is shown. As illustrated, the system 300 for atmospheric water harvesting includes an unmanned aerial vehicle (UAV) 310, a base station 320, a power source 330, and a water distribution system 340.

In one embodiment, the UAV 310 includes a processor 311, a camera 312, one or more sensors 313 (such as an altimeter, a humidistat, a global positioning system (GPS) sensor, a gyroscope, and the like), a battery 314, a communications device, and a fog harvesting fabric 316. In exemplary embodiments, the processor 311 is configured to control a flight path and flight characteristics of the UAV 310. The processor is also configured to receive data from the sensors 313 and the communications device 315. In exemplary embodiments, the processor 311 is configured to analyze images captured by the camera 312. For example, the processor 311 may analyze the images to assign a blurriness score to one or more regions of the image. The assigned blurriness score can be used to identify areas within the harvesting area that include various amounts of fog. For example, a high blurriness score can indicate a high level of fog and a low blurriness score can indicate a low level of fog. Based on the analysis of the images captured by the camera 212 the processor 311 can control the fight path of the UAV to maximize the efficiency of the atmospheric water harvesting.

In one embodiment, the base station 320 includes a water reservoir 322 that is connected to the fog harvesting fabric 316 by tubing 304. The tubing 304 is configured to transfer water collected by the fog harvesting fabric 316 to the water reservoir 322. In one embodiment, the tubing 304 includes conductive elements that are configured to provide power to the UAV 310 from the base station 320 and to facilitate communications between the base station 320 and the UAV 310. The base station 220 also includes a processor 321, one or more sensors 323, and a communications device 325. The processor 321 is configured to selectively deploy the UAV 310 to perform atmospheric water harvesting based at least in part on data received from the sensors 323. The sensors 323 are configured to monitor atmospheric conditions in an area around the base station 320 and to monitor a water level in the water reservoir 322. In one embodiment, the communications device 325 is configured to receive data regarding the spheric conditions in an area around the base station 320 from external sources, such as from online information sources).

In one embodiment, the power source 330 is configured to provide power to operate the base station 320 and the UAV 310. The power source 330 can include solar, hydro, and wind-based power generation device as well as power storage devices (i.e., batteries). In some embodiments, the power source 330 can include a traditional power distribution system as well. The water distribution system 340 is configured to draw water from the water reservoir 322 and to provide water to buildings, agricultural irrigation systems, and the like.

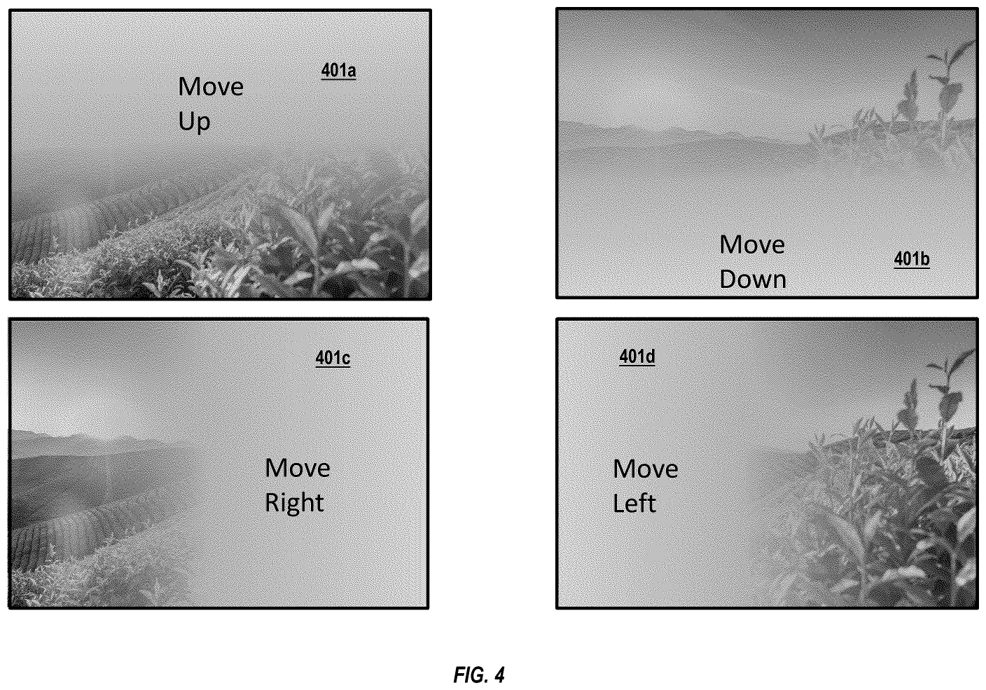

Referring now to FIG. 4, images 401a, 401b, 401c, and 401d (referred to herein collectively as images 401) captured by an unmanned aerial vehicle (UAV) that are used during atmospheric water harvesting by the UAV in accordance with one or more embodiments of the present disclosure are shown. As illustrated, each of the images 401 includes at least one portion that has a blurred, or obstructed view, and another portion that includes a clear view. In exemplary embodiments, the processor of the UAV is configured to analyze the images 401 and to responsively adjust the flight path of the UAV to increase the efficiency of the atmospheric water harvesting, (i.e., to fly the UAV through an area that has more dense fog). For example, based on the analysis of image 401a, the processor of the UAV would adjust the flight path of the UAV to move to a higher altitude. Based on the analysis of image 401b, the processor of the UAV would adjust the flight path of the UAV to move to a lower altitude. Based on the analysis of image 401d, the processor of the UAV would adjust the flight path of the UAV to move to the right and based on the analysis of image 401d, the processor of the UAV would adjust the flight path of the UAV to move to the left.

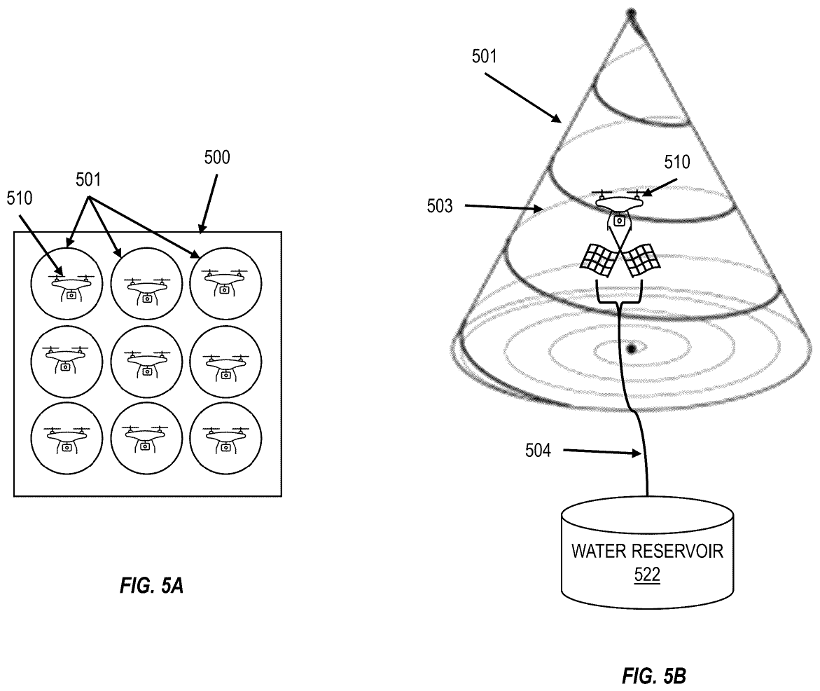

Referring now to FIG. 5A, a schematic diagram of a system for atmospheric water harvesting including a plurality of UAVs in accordance with one or more embodiments of the present disclosure is shown. As illustrated, the system includes a geographic area 500 that has plurality of UAVs 510 that area each configured to operate in a harvesting area 501. In one embodiment, the geographic area 500 is an area that is prone to the accumulation of dense fog, such as coastal areas, mountains areas, valleys and low-lying areas. Coastal areas, especially those near cool ocean currents, often experience fog due to the temperature difference between the warm land and the cold sea. As the moist air from the ocean moves inland and encounters the cooler land, it can condense into fog. Higher elevations, such as mountain ranges, are susceptible to fog formation. When humid air is forced to rise over mountains, it cools, and its moisture condenses, leading to the formation of fog on the windward side of the mountains. Valleys and low-lying areas tend to trap cool, moist air, which can create favorable conditions for fog formation. These areas often have temperature inversions, where a layer of cool air is trapped beneath a layer of warmer air, leading to the condensation of moisture. In exemplary embodiments, only a single UAV 510 is disposed in each harvesting area 501 and the tubing affixed to the UAV 510 prevents the UAV from leaving the harvesting area 501 to ensure that the UAVs 510 disposed in adjacent harvesting areas 501 do not become entangled. In exemplary embodiments, each of the UAVs 510 are configured to operate above a minimum operational altitude to prevent the UAVs from impacting trees or structures within the harvesting area 501. In addition, each of the UAVs 510 are configured to operate below a maximum operational altitude to prevent the UAVs from interfering with other aircraft operating in the harvesting area 501.

Referring now to FIG. 5B, a schematic diagram of a system for atmospheric water harvesting using a UAV tethered to a water reservoir in accordance with one or more embodiments of the present disclosure is shown. As illustrated, a UAV 510 is tethered to a water reservoir 522 by tubing 504. The tubing 504 includes a fluid communication path that is configured to transfer water from a fog harvesting fabric connected to the UAV to the water reservoir 522. The tubing 504 also includes an electrical communication path that is configured to transfer power from a base station, including the water reservoir 522, to the UAV 510. In exemplary embodiments, due to the length of the tubing 504 and the minimum operational altitude of the UAV 510, the harvesting area 501 may take the shape of an inverted cone.

In one embodiment, the UAV 510 is configured to traverse the harvesting area 501 by flying a default flight path 503. In one embodiment, the default flight path begins at the minimum operational altitude directly above the water reservoir and spirally extends outward until the edge of the harvesting area 501 is reached, next the default flight path 503 includes traversing an outer edge of the harvesting area 501 while increasing the altitude of the UAV 510. In exemplary embodiments, the UAV is configured to capture images of the harvesting area 501 during the initial flight path and to analyze the captured images to identify dense fog areas within the harvesting area 501. Once the default flight path 503 has been completed, the processor of the UAV directs the UAV 510 to the identified dense fog areas within the harvesting area 501.

In exemplary embodiments, the atmospheric water harvesting process is performed by the UAV until one or more termination conditions are met. The termination conditions can include a water level in the water reservoir connected to the UAV exceeding a maximum level, an atmospheric condition of the harvesting area 501 falling below a minimum level (i.e., the humidity falls below a predefined percentage), or a power level of a battery of the UAV falls below a threshold minimum value. In one embodiment, a determination that an atmospheric condition of the harvesting area 501 falling below a minimum level can be based on one or more sensors disposed on the UAV, one or more sensors based on the base station, or by analysis of images captured by the UAV.

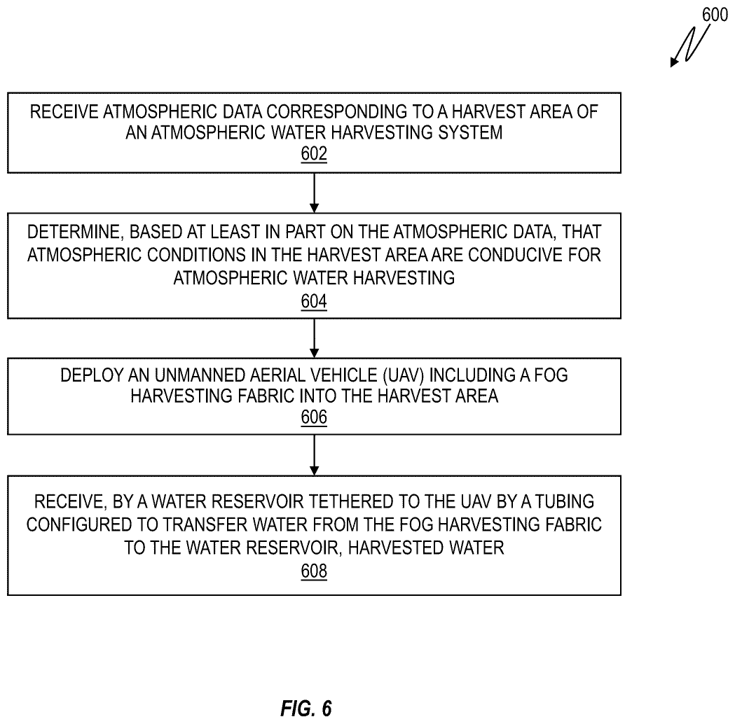

Referring now to FIG. 6 a flowchart of a method 600 for atmospheric water harvesting in accordance with one or more embodiments of the present disclosure is shown. In exemplary embodiments, the method 600 is performed by a processor 321 of the base station 320 such as the one shown in FIG. 3.

At block 602, the method 600 includes receiving atmospheric data corresponding to a harvest area of an atmospheric water harvesting system. In one embodiment, the atmospheric data is received from a sensor disposed in a base station of the atmospheric water harvesting system. In another embodiment, the atmospheric data is received via a communications device of the is received from sensor disposed in the UAV, ground based sensors that not connected to the base station, or from external data sources. For example, the atmospheric data can be received from a commercially available source such as the Weather Channel, the National Oceanic and Atmospheric Administration (NOAA), or the like.

At block 604, the method 600 includes determining, based at least in part on the atmospheric data, that atmospheric conditions in the harvest area are conducive for atmospheric water harvesting. In one embodiment, the determination that atmospheric conditions in the harvest area are conducive for atmospheric water harvesting is based on determining that an atmospheric moisture level in the harvest area is above a threshold value. The method 600 may also include monitoring a water level in the water reservoir and wherein the threshold value is determined based at least in part on the water level.

Next, at block 606, the method 600 includes deploying an unmanned aerial vehicle (UAV) including a fog harvesting fabric into the harvest area. Once deployed in the harvest area, the UAV performs atmospheric water harvesting using the fog harvesting fabric. In exemplary embodiments, the harvest area is defined by a minimum operating altitude of the UAV and the length of the tubing. In one embodiment, the UAV is configured to traverse the harvest area based on a default flight path. In one embodiment, the UAV includes a camera and a processor configured to analyze images captured by the camera and wherein the UAV is configured to traverse the harvest area based at least in part on an analysis of images captured by the camera during a water harvesting process.

At block 608, the method 600 includes receiving, by a water reservoir tethered to the UAV by a tubing configured to transfer water from the fog harvesting fabric to the water reservoir, harvested water. The method 600 may also include activating a water distribution system configured to draw water from the water reservoir based on the water level being above a maximum level.

In exemplary embodiments, the UAV may be commanded to return to the base station based on various conditions. For example, the base station may instruct the UAV to return to the base station based on a determination that the water level in the water reservoir is above a threshold value (e.g., the water reservoir is almost full). In another example, the base station may instruct the UAV to return to the base station based on a determination that a wind speed in the harvesting area is higher a threshold level, such as an advised maximum drone operating condition. In a further example, the base station may instruct the UAV to return to the base station based on a determination that the atmospheric conditions for water harvesting in the harvesting area are no longer detected.

In exemplary embodiments, the UAV may be configured to return to the base station upon detecting that the battery level of the UAV is below a threshold level or detecting a mechanical failure detected (e.g., loss of fabric or tether). In exemplary embodiments, when a mechanical failure detected, a message indicating the occurrence of the mechanical failure will be transmitted to a central system that is configured to monitor the atmospheric water harvesting activity, which may trigger the dispatch of a human technician to the site to assess the damage and make repairs.

In exemplary embodiments, the UAV is tethered to a base station via tubing that is configured to stored on a spool. In one embodiment, the spool includes one or more springs that are configured to automatically reel the tubing on the spool as the UAV returns to the base station and to automatically dispense the tubing as the UAV flies away from the base station. The spool is configured to prevent slack in the tubing and to optimize the water drainage from the UAV to the water reservoir. In addition, the spool is configured to reduce the risks of the tubing becoming kinked, tangled, or knotted.

Various embodiments are described herein with reference to the related drawings. Alternative embodiments can be devised without departing from the scope of the present disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. An atmospheric water harvesting system comprising:
a power source;
an unmanned aerial vehicle (UAV) including a fog harvesting fabric; and
a base station, configured to receive power from the power source, the base station having processor and a water reservoir, wherein the water reservoir is tethered to the UAV by a tubing configured to transfer water from the fog harvesting fabric to the water reservoir,
wherein the processor of the base station is configured to selectively deploy the UAV based on atmospheric conditions in a geographic area including the atmospheric water harvesting system.

2. The atmospheric water harvesting system of claim 1, wherein the tubing includes a conductive material configured to provide power to the UAV from the base station.

3. The atmospheric water harvesting system of claim 1, wherein the UAV is configured to traverse a harvest area in the geographic area, wherein the harvest area is at least partially defined by a minimum altitude.

4. The atmospheric water harvesting system of claim 3, wherein the harvest area is further defined by a length of the tubing.

5. The atmospheric water harvesting system of claim 3, wherein the UAV includes a camera and a processor configured to analyze images captured by the camera and wherein the UAV is configured to traverse the harvest area based at least in part on an analysis of images captured by the camera during a water harvesting process.

6. The atmospheric water harvesting system of claim 3, wherein the UAV is configured to traverse the harvest area based on a default flight path.

7. The atmospheric water harvesting system of claim 1, wherein the water reservoir is fluidly connected to a water distribution system that is configured to distribute water stored by the water reservoir.

8. The atmospheric water harvesting system of claim 1, wherein the base station includes one or more sensors configured to monitor one or more of the atmospheric conditions in the geographic area and a water level in the water reservoir.

9. The atmospheric water harvesting system of claim 1, wherein the power source includes one of a solar power source and a wind power source.

10. The atmospheric water harvesting system of claim 1, wherein the base station includes a communications device configured to receive data regarding the atmospheric conditions in the geographic area.

11. A method for atmospheric water harvesting, the method comprising:
receiving atmospheric data corresponding to a harvest area of an atmospheric water harvesting system;
determining, based at least in part on the atmospheric data, that atmospheric conditions in the harvest area are conducive for atmospheric water harvesting;
deploying an unmanned aerial vehicle (UAV) including a fog harvesting fabric into the harvest area; and
receiving, by a water reservoir tethered to the UAV by a tubing configured to transfer water from the fog harvesting fabric to the water reservoir, harvested water.

12. The method of claim 11, wherein the atmospheric data corresponding to the harvest area is received from one or more of a sensor and a communications device of the atmospheric water harvesting system.

13. The method of claim 11, wherein the determination that the atmospheric conditions in the harvest area are conducive for atmospheric water harvesting is based on determining that an atmospheric moisture level in the harvest area is above a threshold value.

14. The method of claim 13, further comprising monitoring a water level in the water reservoir, and wherein the threshold value is determined based at least in part on the water level.

15. The method of claim 14, further comprising activating a water distribution system configured to draw water from the water reservoir based on the water level being above a maximum level.

16. The method of claim 11, wherein the harvest area is defined by a minimum operating altitude of the UAV and a length of the tubing.

17. The method of claim 11, wherein the UAV includes a camera and a processor configured to analyze images captured by the camera and wherein the UAV is configured to traverse the harvest area based at least in part on an analysis of images captured by the camera during a water harvesting process.

18. The method of claim 11, wherein the UAV is configured to traverse the harvest area based on a default flight path.

19. A computing system having a memory having computer readable instructions and one or more processors for executing the computer readable instructions, the computer readable instructions controlling the one or more processors to perform operations comprising:
receiving atmospheric data corresponding to a harvest area of an atmospheric water harvesting system;
determining, based at least in part on the atmospheric data, that atmospheric conditions in the harvest area are conducive for atmospheric water harvesting;
deploying an unmanned aerial vehicle (UAV) including a fog harvesting fabric into the harvest area; and
receiving, by a water reservoir tethered to the UAV by a tubing configured to transfer water from the fog harvesting fabric to the water reservoir, harvested water.

20. The computing system of claim 19, wherein the UAV includes a camera and a processor configured to analyze images captured by the camera and wherein the UAV is configured to traverse the harvest area based at least in part on an analysis of images captured by the camera during a water harvesting process.
